(19) United States
(12) Patent Application Publication
(10) Pub. No.: US 2025/0282442 A1
(43) Pub. Date: Sep. 11, 2025

(54) CARBON FIBER TRACK BICYCLE AND MANUFACTURING METHOD THEREOF

(71) Applicant: Qingdao University of Technology, Qingdao (CN)

(72) Inventors: Wenhao XU, Qingdao (CN); Changhe LI, Qingdao (CN); Peiming XU, Qingdao (CN); Wei WANG, Qingdao (CN); Chunqing WANG, Qingdao (CN); Longxun DENG, Qingdao (CN); Jinquan NIE, Qingdao (CN); Yanbin ZHANG, Qingdao (CN); Changhe JI, Qingdao (CN)

(73) Assignee: Qingdao University of Technology, Qingdao (CN)

(21) Appl. No.: 18/625,244

(22) Filed: Apr. 3, 2024

(30) Foreign Application Priority Data
Mar. 7, 2024 (CN) 202410262066.1

(51) Int. Cl. B62K 19/16; B62K 3/04

(52) U.S. Cl. CPC B62K 19/16; B62K 3/04

(57) ABSTRACT

Provide are a carbon fiber field bicycle and a manufacturing method thereof. The frame includes a frame formed by the integrated solidification of carbon fiber. The frame includes a front triangular structure composed of an upper tube, a lower tube, and a seat tube; and a rear triangular structure composed of a seat branch tube, a transmission branch tube, and a seat tube. The fiber layers corresponding to the tube fittings forming the front triangular structure is distributed along the axial direction of the corresponding tube fittings. In view of the current problem of poor strength and rigidity of track bicycles, a carbon fiber integrated frame is adopted as the main structure, and the fiber layer distribution of each tube component and key node position of the frame is optimized to ensure continuous distribution of carbon fibers and improve the strength of track bicycles.

### CROSS-REFERENCE TO RELATED APPLICATIONS

This application claims priority to Chinese Patent Application No. 202410262066.1 with a filing date of Mar. 7, 2024. The content of the aforementioned application, including any intervening amendments thereto, is incorporated herein by reference.

### TECHNICAL FIELD

The present disclosure relates to the technical field of track bicycle, in particular to a carbon fiber track bicycle and a manufacturing method thereof.

### BACKGROUND

Track cycling is a specialized branch of cycling that is designed specifically for the track, with the aim of providing maximum speed and efficiency during closed track races. The research on existing technologies covers fields such as frame, saddle, transmission system, and integrated practical bicycles. The Chinese patent (public number CN108163111B) discloses a bicycle that improves the stability of bicycle parking, and the Chinese patent (public number CN107323599B) discloses a new type of bicycle without spokes, which reduces the structural complexity of the bicycle by setting up a structure without spokes. However, these studies have significant differences compared to track bicycles, which have stricter requirements for body weight, component structure, and assembly methods in design and performance.

The Chinese patent application (public number CN103303417A) discloses a frame composed of multiple carbon fiber tube bodies joined together. The Chinese patent (public number CN106564551A) provides an integral frame to solve the problem of non-compact structure, and the Chinese patent (public number CN101715406A) achieves frame connection through a folding joint. However, there is still a problem of discontinuity in the component structure. Track bikes or their components, such as the frame, still use a multi-stage assembly method, resulting in carbon fiber discontinuity, which affects the rigidity and strength of the product, and thus affects the comfort and explosive power of riding. At present, insufficient consideration has been given to the cross-sectional shape, tube shape, and weight distribution in the design of the frame, causing bicycles to fail to fully utilize their excellent aerodynamic performance. The existing technology of track bicycles or their components often has complex assembly methods, which may be better for multi-purpose bicycles, but the operational requirements for bicycles that pursue competitiveness, high stability, and high human machine compatibility are poor. The complex assembly method increases the connection points, reduces the overall closure degree, leads to poor stability and increased air resistance.

### SUMMARY OF PRESENT INVENTION

The objective of the present disclosure is to provide a carbon fiber track bike and a manufacturing method thereof to solve the shortcomings of existing technology. The main structure is a carbon fiber integrated frame, and the fiber layer distribution of each tube component and key node position of the bike frame is optimized to ensure continuous distribution of carbon fibers and improve the strength of the track bike.

The first objective of the present disclosure is to provide a carbon fiber track bicycle, adopting the following solution:

A carbon fiber track bicycle, including a frame formed by carbon fiber integrated solidification, wherein the frame includes a front triangular structure composed of an upper tube, a lower tube, and a seat tube, and a rear triangular structure composed of a seat branch tube, a transmission branch tube, and a seat tube; fiber layers corresponding to tube fittings forming the front triangular structure is distributed along an axial direction of the corresponding tube fittings; the seat branch tube is distributed with fiber layers in two different directions, the transmission branch tube is distributed with fiber layers in three different directions, and a five-way tube are distributed with fiber layers in four different directions.

Further, two distribution directions of the fiber layers corresponding to the seat branch tube are perpendicular, two distribution directions of the fiber layers corresponding to the transmission branch tube are perpendicular, and another distribution direction is located on an angular bisector of the two distribution directions.

Further, four distribution directions of the fiber layers corresponding to the five-way tube are arranged in an asterisk shape.

Further, a cross-section area of an upper tube perpendicular to its axis gradually decreases along a direction from a front wheel to a rear wheel, and an outer circumference of the upper tube is a conical surface; a cross-section of the lower tube perpendicular to its axis direction is elliptical in shape, and a head tube is provided at the junction of the upper tube and the lower tube using a surface extension; and the seat tube uses a box tube type.

Further, a top surface of the upper tube extends a airfoil protrusion, and an outer surface of the airfoil protrusion is streamlined.

Further, an embedded block is provided at a connection position between the transmission branch tube and the seat branch tube, and a U-shaped groove with an opening facing backwards is provided on the embedded block.

Further, the seat tube is matched with a seat support tube, and a seat system is connected above the seat support tube; the seat system includes a saddle, a support frame, and an adjustment assembly; the saddle is fixed to the support frame, and the support frame is connected to the seat support tube through the adjustment assembly.

Further, the saddle is a streamlined structure, the seat support tube is in a sliding insertion connection with the seat tube are in a sliding insertion connection, and provided with a locking structure.

The second objective of the present disclosure is to provide a manufacturing method for a carbon fiber track bicycle, including:
cutting carbon fiber cloth to obtain carbon cloth pieces, and winding the carbon cloth pieces into an inner core mold according to a preset layout method;
painting a mold release agent to an outer mold shell, then placing the inner core mold wrapped with the carbon cloth pieces inside the outer mold shell;
heating and pressurizing to solidify the carbon cloth pieces into shape, removing the inner core mold to obtain a carbon fiber integrated frame;
installing other assemblies of the track bike onto the carbon fiber integrated frame.

Further, the carbon cloth pieces are wound according to a laying manner and quantity, and adjacent carbon cloth pieces are spliced together along the width direction at the carbon fiber connection.

Compared with related arts, the advantages and positive effects of the present disclosure are shown as below:

(1) In view of the current problem of poor strength and rigidity of track bicycles, a carbon fiber integrated frame is adopted as the main structure, and the fiber layer distribution of each tube component and key node position of the frame is optimized to ensure continuous distribution of carbon fibers and improve the strength of track bicycles.

(2) The head tube, the upper tube, the lower tube, the seat tube, the transmission branch tube, and the seat branch tube of the key component frame all adopt different cross-sectional designs, and each tube type is designed asymmetrically; adopting a curved gradient streamline, different tube types are designed for the positions of the foot pedal transmission five way, the head tube installation position, the vehicle tube installation position, and the connection position of the transmission branch tube; the overall aerodynamic optimization is carried out using different cross-sectional tube types to reduce wind resistance and improve the aerodynamic performance of the entire vehicle.

(3) Adopting an integrated bending handle overall structural design, the handlebars and the top of the front fork tube can be designed as one to reduce seams and air resistance; designed with easy-to-use and reliable seat adjustments, the adjustment system is hidden inside the frame to reduce wind resistance points and ensure structural integrity and overall structural aerodynamics, and the ergonomic saddle is designed to reduce pressure points and avoid discomfort while riding.

(4) Based on EPS of lost foam casting process technology and integrated molding technology, the frame is processed, and the fiber distribution direction of each carbon fiber layer of the tube fittings is designed separately. The laid carbon fiber layers ensure that the carbon fiber connection is spliced along the width direction, controls the splicing gap, and achieves integrated molding of the frame.

### BRIEF DESCRIPTION OF THE DRAWINGS

The accompanying drawings of the specification, which form a part of the present disclosure, are used to provide a further understanding of the present disclosure. The illustrative embodiments and their illustration of the present disclosure are used to illustrate the present disclosure and do not constitute an improper limitation of the present disclosure.

FIG. 1 shows an axonometric view of the track bicycle in embodiments 1 and 2 of the present disclosure;

FIG. 2 shows a front view of the track bicycle in embodiments 1 and 2 of the present disclosure;

FIG. 3 shows an axonometric view of the track bicycle frame in embodiments 1 and 2 of the present disclosure;

FIG. 4 (a) shows a front view of the track bicycle frame in embodiments 1 and 2 of the present disclosure;

FIG. 4 (b) is a top view of the track bicycle frame in embodiments 1 and 2 of the present disclosure;

FIG. 5 shows a sectional view of the track bicycle frame in embodiments 1 and 2 of the present disclosure;

FIG. 6 shows the degradable epoxy resin carbon fiber composite material recycling system used in embodiments 1 and 2 of the present disclosure;

FIG. 7 is a schematic diagram of the distribution of carbon fiber layers in various parts of the track bicycle frame in embodiments 1 and 2 of the present disclosure;

FIG. 8 shows an axonometric view of the handlebars of the track bicycle in embodiments 1 and 2 of the present disclosure;

FIG. 9 (a) is a top view of the handlebars of the track bicycle in embodiments 1 and 2 of the present disclosure;

FIG. 9 (b) shows a sectional view of the handlebars of a track bicycle in embodiments 1 and 2 of the present disclosure;

FIG. 10 shows an axonometric view of the front fork of the track bicycle in embodiments 1 and 2 of the present disclosure;

FIG. 11 (a) shows a front view of the front fork of the track bicycle in embodiments 1 and 2 of the present disclosure;

FIG. 11 (b) shows a left view of the front fork of the track bicycle in embodiments 1 and 2 of the present disclosure;

FIG. 12 shows a partial sectional view of the connection of the bicycle frame, the handlebars, and the front fork in embodiments 1 and 2 of the present disclosure;

FIG. 13 (a) shows a main view of the front wheels of the track bicycle in embodiments 1 and 2 of the present disclosure;

FIG. 13 (b) shows a front view of the rear wheels of the track bicycle in embodiments 1 and 2 of the present disclosure;

FIG. 13 (c) shows a sectional view of the rear wheels of the track bicycle in embodiments 1 and 2 of the present disclosure;

FIG. 14 shows an axonometric view of the saddle of the track bicycle in embodiments 1 and 2 of the present disclosure;

FIG. 15 (a) shows a top view of the saddle of the track bicycle in embodiments 1 and 2 of the present disclosure;

FIG. 15 (b) shows a front view of the saddle of the track bicycle in embodiments 1 and 2 of the present disclosure;

FIG. 16 is an exploded view of the seat system in embodiments 1 and 2 of the present disclosure;

FIG. 17 is a top view of the seat system in embodiments 1 and 2 of the present disclosure;

FIG. 18 is an enlarged partial view of the adjustment part of the seat system in embodiments 1 and 2 of the present disclosure.

In the drawings: I. frame, II. handlebar, III. front fork, IV. front wheel, V. rear wheel, VI. seat system, VII. first bearing, VIII. connecting shaft sleeve, IX. second bearing, X. bearing seat, I-1. upper tube, I-2. lower tube, I-3. seat tube, I-4. seat branch tube, I-5. transmission branch tube, I-6. head tube, I-7. five-way tube; VI-1. saddle, VI-2. support frame, VI-3. first frame support block, VI-4. first buckle block, VI-5. support base, VI-6. second frame support block, VI-7. second buckle block, VI-8. positioning connection block, VI-9. adjustable double-end stud, VI-10. seat support tube, VI-11. short screw, VI-12. long screw.

### DETAILED DESCRIPTION OF THE EMBODIMENTS

### Embodiment 1

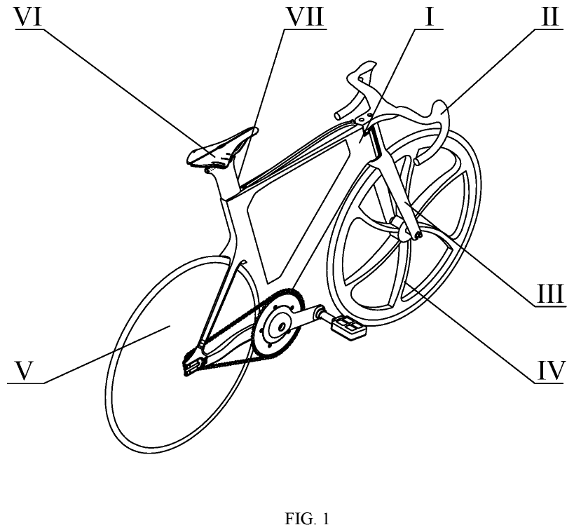

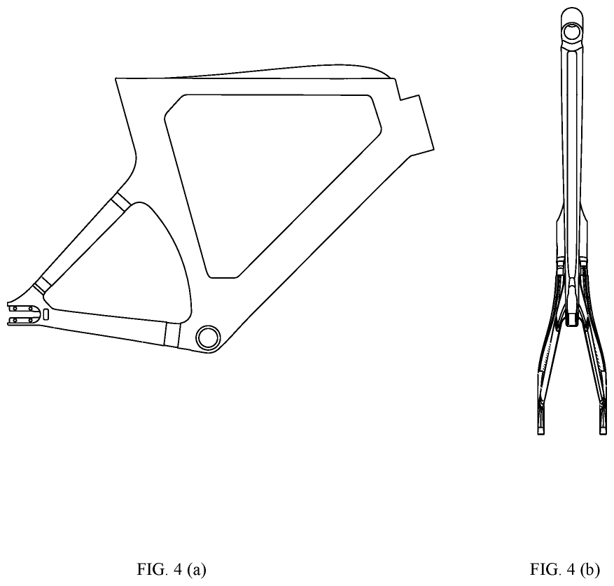

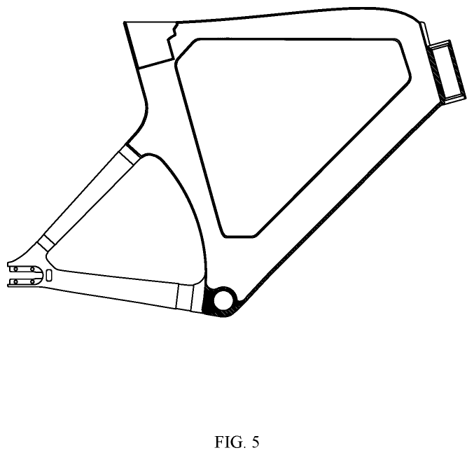

In a typical embodiment of the present disclosure, as shown in FIG. 1 to FIG. 18, a carbon fiber track bicycle is provided.

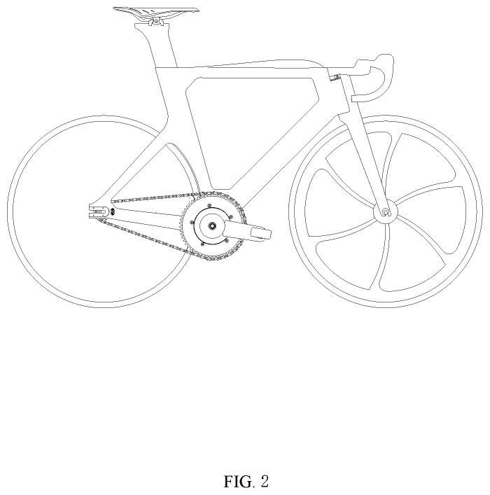

As shown in FIG. 1 and FIG. 2, the carbon fiber track bicycle includes a frame I, a handlebar II, a front fork III, a front wheel IV, a rear wheel V, and a seat system VI. The frame I is a key component to ensure the performance and safety of athletes, meeting the requirements of speed, stability, weight, and strength. The frame I is made of carbon fiber by integrated solidification as a whole, including a front triangular structure composed of an upper tube I-1, a lower tube I-2, and a seat tube I-3, and a rear triangular structure composed of a seat branch tube I-4, a transmission branch tube I-5, and a seat tube I-3. As shown in FIG. 2, the carbon fiber track bike is designed with a streamlined structure as a whole.

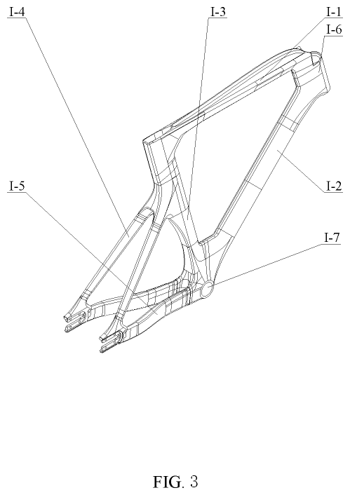

As shown in FIGS. 3, 4 (a), 4 (b), and 5, the upper tube I-1 structure of the frame I adopts a gradient conical surface design, and an airfoil structure design is used above the upper tube I-1 to reduce wind resistance. Thereby, the corresponding aerodynamic streamlined tube shape is used in the complex upper tube I-1 structure. The lower tube I-2 adopts an elliptical tube design. The junction between the lower tube I-2 and the upper tube I-1 is equipped with an integrated cylindrical structure using a surface extension to connect with the handlebar II and the front fork III components. The seat tube I-3 adopts a curved gradient tube design. There is a reserved space at the junction of the seat tube I-3 and the upper tube I-1 to connect with the seat bottom tube. The curved surface at the seat tube I-3 extends to form a symmetrical seat branch tube I-4, and installation holes are designed at the junction of the seat tube I-3 and the lower tube I-2 to facilitate the connection of the transmission structure. The transmission branch tube I-5 is connected to the seat branch tube I-4, the lower tube I-2, and the seat tube I-3, and a streamlined tube design is used to ensure reasonable installation of the wheel system while reducing wind resistance. Asymmetric tube design is used at the key points of power transmission, such as seat tube I-3 and transmission connections, to increase the rigidity of these areas and improve overall driving efficiency. In addition, a U-shaped groove embedded block design is used at the connection between the transmission branch tube I-5 and the seat branch tube I-4 to facilitate the connection of the wheel system. The overall structure is symmetrically distributed, and each edge and corner is used variable fillet design to minimize air resistance.

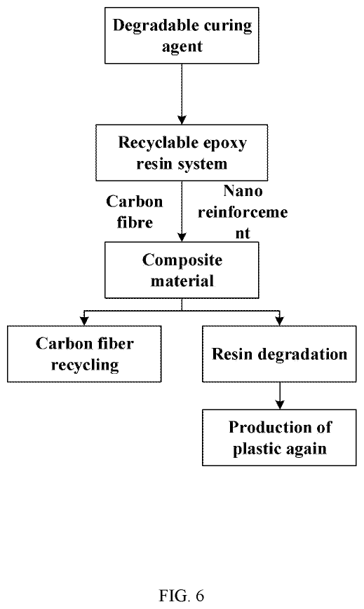

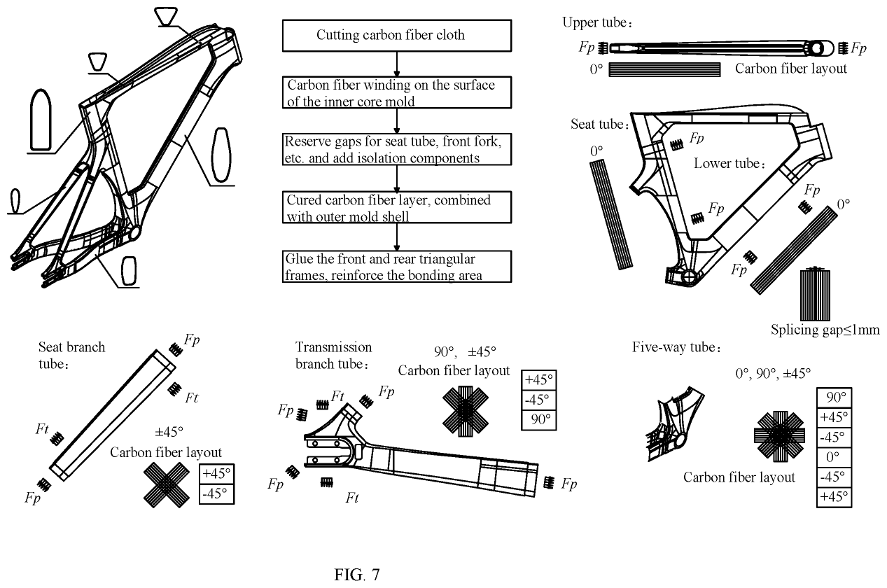

As shown in FIG. 6 and FIG. 7, a fully automatic intelligent yarn cutting machine is used to cut the pre-designed and optimized carbon fiber cloth into carbon cloth pieces of different shapes. The carbon cloth pieces are wound onto the pre-made inner core mold, and the wound inner core mold is placed in the outer mold shell. Before entering the mold, the mold release agent is painted on the outer mold shell, then the air nozzle is locked, and then the frame I is solidified and formed in a certain shape by heating and pressurizing. The inner core mold is decomposed at high temperature to be removed.

As shown in FIG. 7, the carbon fiber cloth laid on the surface of the inner core mold is configured based on the target direction of carbon fibers at each position. The fiber layers inside the carbon fiber cloth laid on the upper tube I-1, the lower tube I-2, and the seat tube I-3 are distributed along the 0 degree direction, which are distributed along the axial direction of the corresponding tube fittings, to resist the tensile force generated by the forward pushing of frame I during cycling, and provide sufficient bending rigidity to maintain cycling posture and efficiency.

The seat branch tube I-4 is distributed with fiber layers in two different directions, and the fiber layers inside the carbon fiber cloth laid on the seat branch tube I-4 is distributed along the ±45° direction, ensuring that it can withstand the tensile and shear stresses applied by the seat tube I-3 and the tire support shaft. After obtaining the number of layers of carbon fiber cloth on the seat branch tube I-4, the distribution directions of the fiber layers in adjacent layers of carbon fiber cloth are perpendicular to each other, as shown in FIG. 7. The fibers in one layer of the fiber layers inside the carbon fiber cloth are arranged along the +45° direction relative to the axis of the seat branch tube I-4, while the fibers in the adjacent layer of the fiber layers inside the carbon fiber cloth are arranged along the −45° direction relative to the axis of the seat branch tube I-4.

The transmission branch tube I-5 is distributed with fiber layers in three different directions. The fiber layers inside the carbon fiber cloth laid on the transmission branch I-5 are distributed along the 90 degree and #45 degree directions, so that two distribution directions of the fiber layers corresponding to the transmission branch tube I-5 are perpendicular to each other, and another distribution direction is located on an angular bisector of the two distribution directions, ensuring that they can withstand the tensile and shear stresses applied by the seat tube I-3, the tire support shaft, and the pedal force. After obtaining the number of layers of carbon fiber cloth on the transmission branch tube I-5, for the three layers of carbon fiber cloth stacked sequentially, as shown in FIG. 7, the fibers in one layer of the fiber layers inside the carbon fiber cloth are arranged in the 90° direction relative to the axis of the transmission branch tube I-5, and the fibers in the other layer of the fiber layers inside the carbon fiber cloth, which are spaced apart from the former layer, are arranged in the +45° direction relative to the axis of the transmission branch tube I-5. The fibers in another layer of the fiber layers inside the carbon fiber cloth located between the two layers of carbon fiber cloth mentioned above are arranged in the −45° direction relative to the axis of the transmission branch tube I-5.

The five-way tube I-7 is distributed with fiber layers in four different directions, and the fiber layers inside the carbon fiber cloth laid on the five-way tube I-7 are distributed along 0 degree, 90 degree, and ±45 degree directions, so that four distribution directions of the fiber layers corresponding to the five-way tube are arranged in an asterisk shape to resist torsion and shear forces, and increase the local rigidity and strength at the high stress five-way tube I-7. After obtaining the number of layers of carbon fiber cloth on the five-way tube I-7, for the four layers of fiber cloth stacked sequentially, as shown in FIG. 7, the fibers in the first fiber layer of carbon fiber cloth are arranged in a 90° direction relative to the axis of the five-way tube I-7, the fibers in the adjacent second fiber layer of carbon fiber cloth are arranged in the +45° direction relative to the axis of the five-way tube I-7, the fibers in the third fiber layer of carbon fiber cloth are arranged in the −45° direction relative to the axis of the five-way tube I-7, the fibers in the fourth fiber layer of carbon fiber cloth are arranged in the 0° direction relative to the axis of the five-way tube I-7, and the fibers in the fifth fiber layer of carbon fiber cloth are arranged in the 0° direction relative to the axis of the five-way tube I-7. The fibers in the fifth fiber layer of carbon fiber cloth are arranged along the −45° direction relative to the axis of the five-way tube I-7, while the fibers in the sixth fiber layer of carbon fiber cloth are arranged along the +45° direction relative to the axis of the five-way tube I-7. The axis direction of the five-way tube I-7 refers to the axis direction at the connection position between the five-way tube I-7 and other tube fittings.

The number of layers of carbon fiber cloth is calculated based on the maximum design stress and the ultimate tensile strength of the single-layer carbon fiber material. For the seat branch tube I-4, when laying layers, it is necessary to ensure that the carbon fiber cloth layers in different directions are symmetrical, that is, the number of the carbon fiber cloth layers should be taken as an integer multiple of 4 from the theoretical calculation value. For the transmission branch tube I-5, when laying layers, it is necessary to ensure that the carbon fiber cloth layers in different directions are symmetrical, that is, the number of layers should be taken as an integer multiple of 6 from the theoretical calculation value. For the five-way connection, when laying layers, it is necessary to ensure that the carbon fiber cloth layers in different directions are symmetrical, that is, the number of layers should be taken as an integer multiple of 12 from the theoretical calculation value. For multi-directional layered fibers, it is necessary to ensure the symmetry of the fiber direction along the center.

As shown in FIG. 3, the overall structure of the frame I is a diamond structure, including a front triangular structure composed of the upper tube I-1, the lower tube I-2, and the seat tube I-3, and a rear triangular structure composed of the seat branch tube I-4, the transmission branch tube I-5, and the seat tube I-3. In the direction from the front wheel to the rear wheel, the cross-sectional area of the upper tube perpendicular to its axis gradually decreases, and the outer circumference of the upper tube is a conical surface; the cross-section of the lower tube I-2 perpendicular to its axis direction is elliptical in shape, and the junction of the upper tube I-1 and the lower tube I-2 is extended with a curved surface to set the head tube I-6; the seat tube I-3 adopts a box tube type.

Specifically, as shown in FIG. 7, the upper tube I-1 structure of the frame I adopts a gradient conical surface design. The top surface of the upper tube I-1 extends a airfoil protrusion, and the outer surface of the airfoil protrusion is streamlined. The upper tube I-1 is designed with an airfoil structure to reduce wind resistance. The lower tube I-2 adopts an elliptical shaped design, and the junction between the lower tube I-2 and the upper tube I-1 adopts a curved surface extension with a head tube I-6 in integrated structure to connect with the handlebar II and the front fork III components. The seat tube I-3 adopts a curved gradient box-shaped design, and there is a reserved space at the junction of the seat tube I-3 and the upper tube I-1 to connect with the seat support rod. The curved surface extends into symmetrical seat support rods, and the five-way tube I-7 is provided with installation holes at the junction of the seat tube I-3 and the lower tube I-2 to facilitate the connection of the transmission structure. The transmission branch tube I-5 is connected to the seat branch tube I-4, the upper tube I-1, and the seat tube I-3, using a The streamlined tube design ensures the reasonable installation of the wheel system while reducing wind resistance. Asymmetric tube design is used at the junction of the five-way tube I-7, which is the key component of power transmission, to increase the rigidity of these areas and improve the overall driving efficiency.

There is an embedded block at the connection position between the transmission branch tube I-5 and the seat branch tube I-4. The embedded block has a U-shaped groove with an opening facing towards the rear, which facilitates the connection of the wheel system. The overall structure is symmetrically distributed, and each edge and corner is used variable fillet design to minimize air resistance.

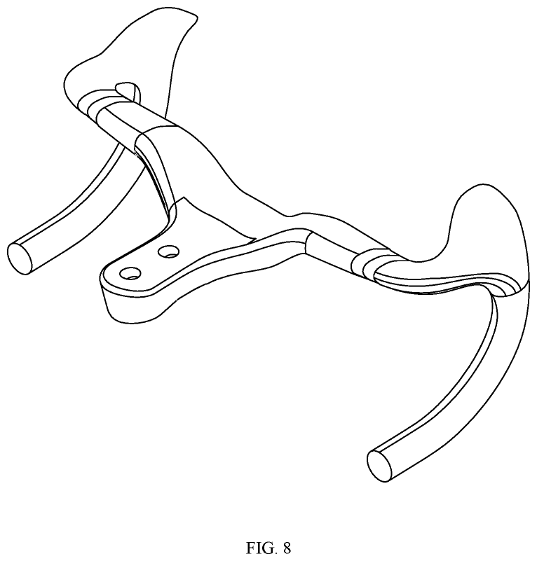

As shown in FIG. 8, the handlebar II adopts a carbon fiber integrated molding design to ensure responsive steering and efficient power transmission. The overall structure of the handlebar II is designed as an integrated handlebar, and the top of the handlebar II, the front fork III, and the head tube I-6 can be designed as a whole to reduce seams, reduce air resistance, and improve overall rigidity. The shape of the handlebar allows riders to adopt a lower and forward leaning posture during the race to reduce air resistance.

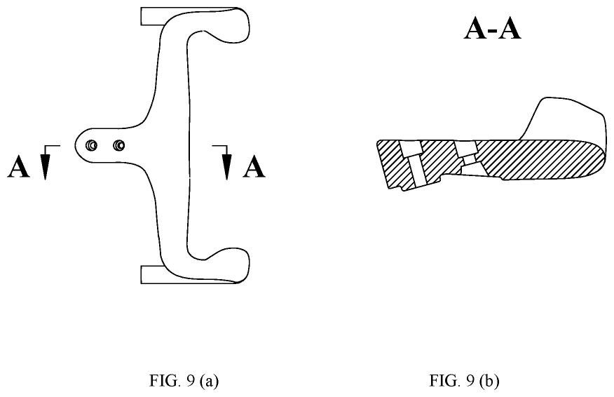

As shown in FIG. 9 (a) and FIG. 9 (b), the overall structure of the handlebar II is symmetrically distributed with respect to the seat tube in the middle. The seat tube in the middle is equipped with two holes for easy connection with the front fork III and the frame I. The structural design of the bent handle conforms to ergonomics and can meet the optimal grip positions for different riders, ensuring effective power output and control during different riding stages while reducing fatigue.

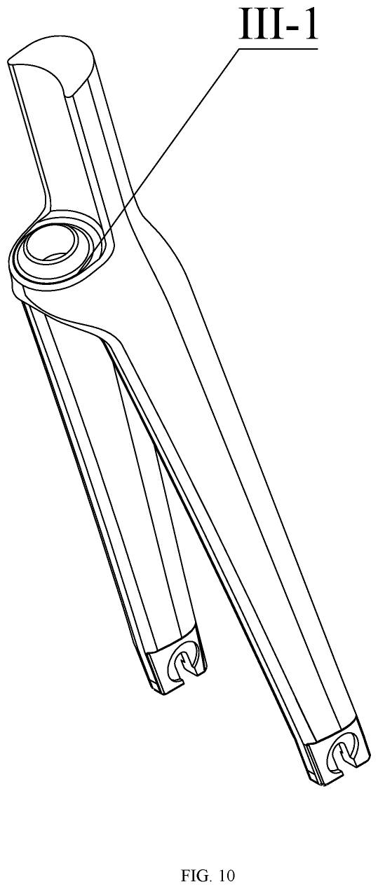

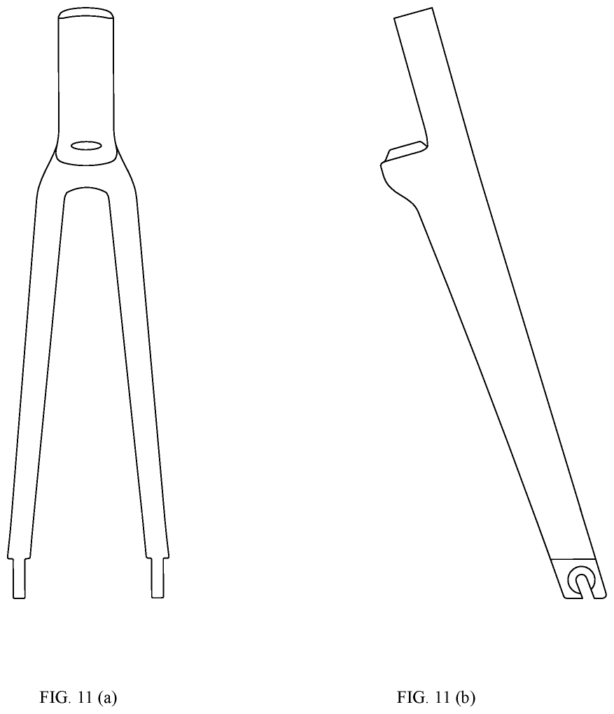

As shown in FIG. 10, FIG. 11 (a), and FIG. 11 (b), the structure of the front fork III can connect to the handlebar II at the upper end, follow the handlebar II to rotate, and connect to the frame I at the middle end. The structural design ensures relative rotation with the frame I, and the lower end is connected to the front wheel IV to control the riding direction. The upper end of the front fork III adopts a front-convex non-closed cylindrical structure, with threaded holes on the side walls of the cylinder, and it is tightly connected to the upper end of the connecting shaft sleeve VIII using screws. The lower part corresponding to the upper cylinder of the front fork III is a closed cylinder, and the outer-convex cylinder of the frame I is placed between the two cylinders. The top of the upper vertical pipe of the front fork III has a threaded hole, and the two lower vertical pipes are symmetrically distributed. The tail of the lower vertical pipe has an installation groove for easy connection and matching with the wheel shaft system.

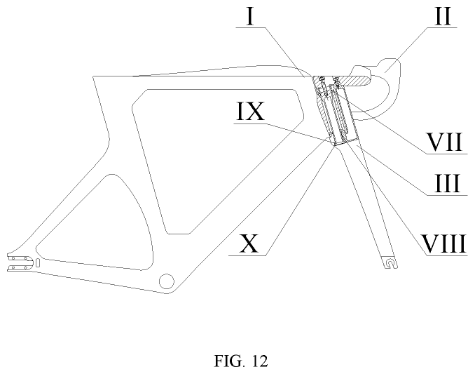

As shown in FIG. 12, the handlebar II is fixedly connected to the top of the vertical tube on the front fork III using screws, and the handlebar II is fixedly connected to the connecting shaft sleeve VIII using screws. The front fork III is equipped with bearings at the upper and lower ends, and the first bearing VII at the upper end is fixed under the joint action of the connecting shaft sleeve VIII and the head tube I-6 of the frame I to support the connecting shaft sleeve VIII. The second bearing IXX at the lower end is fixed under the joint action of the bearing seat X and the front fork III, and the bearing seat X is connected to the front fork III through screws.

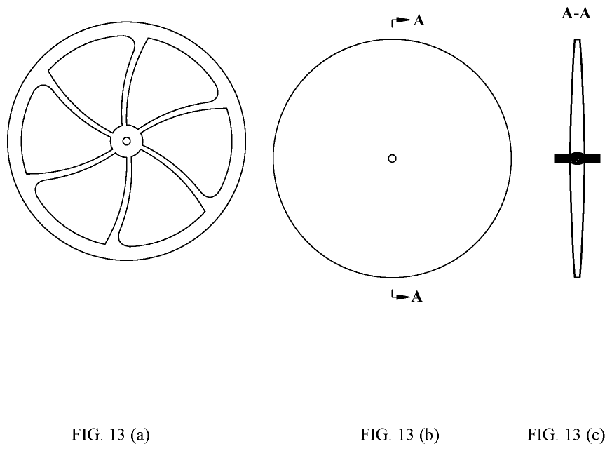

As shown in FIG. 13 (a), FIG. 13 (b), and FIG. 13 (c), the structure of the rear wheel V is a closed disc-shaped wheel rim to improve aerodynamic efficiency. The front wheel IV adopts a wheel hub structure with six spiral spoke bars, and the wheel section is a thin-walled structure with outer curves on both sides and the straight lines at the upper and lower ends to reduce the wind resistance coefficient during wheel operation and improve cycling stability. The center axis of the wheel is easy to connect with the front fork III and the frame I in shafting connection.

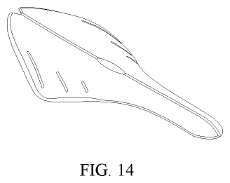

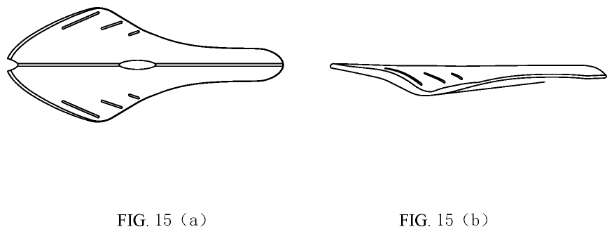

As shown in FIG. 14, FIG. 15 (a), and FIG. 15 (b), the saddle VI-1 adopts a streamlined narrow and long design, with a symmetrical overall structure. The length and width of the saddle VI-1 are designed according to the rider's body shape and riding posture, and comply with ergonomics to reduce resistance, improve riding efficiency, ensure comfort and stability.

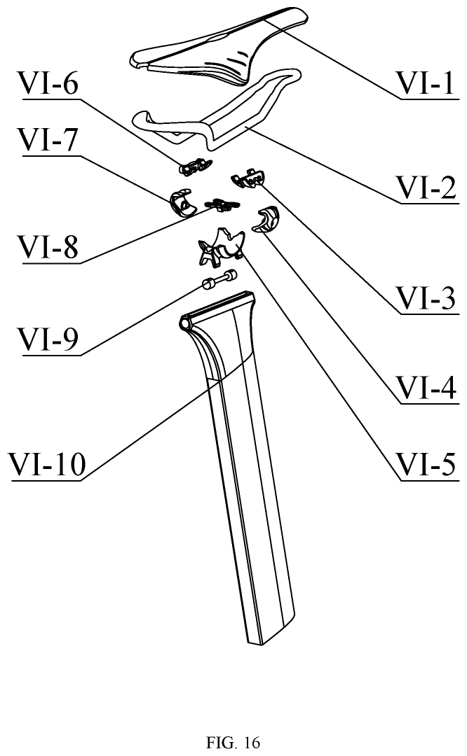

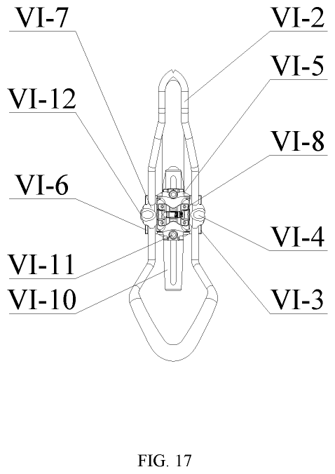

As shown in FIG. 16 and FIG. 17, the seat system VI includes a saddle VI-1, a support frame VI-2, an adjustment assembly, and a support seat tube VI-10. The adjustment assembly includes a first frame support block VI-3, a first buckle block VI-4, a support base VI-5, a second frame support block VI-6, a second buckle block VI-7, a positioning connection block VI-8, an adjustable double-end stud VI-9, a short screw VI-11, and a long screw VI-12.

The first frame support block VI-3 and the second frame support block VI-6 are positioned and fixedly connected to the support base VI-5 through the positioning connection block. Two short screws VI-10 are used to fix and connect the support base VI-5 to an adjustable double-end stud VI-9. The adjustable double-end stud VI-9 has threaded holes at both ends, and the adjustable double-end stud VI-9 is horizontally inserted into the hollow groove at the top of the seat support tube VI-10 to achieve an interference fit. The first buckle block VI-4 and the second buckle block VI-7 are respectively fastened to the support frame VI-2 and the frame support blocks, with one buckle block having a threaded hole in the middle and the other buckle block having a countersunk through-hole. The two are fixedly connected by a long screw VI-12, and the conical head of the support base VI-5 is compressed by a short screw VI-11 to press the seat support tube VI-10 tightly, so as to achieve fixation.

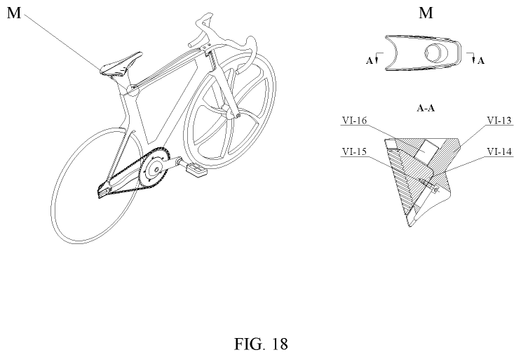

As shown in FIG. 18, the seat adjustment system includes a fixing block VI-13, a damping block VI-14, a screw VI-15, and a headless screw VI-16.

The seat adjustment can be adjusted in height and angle through the seat branch tube VI-10 to adapt to the height and riding posture of different riders. The headless screw VI-16 is used to press down on the damping block VI-14 through the fixing block VI-13 stuck in the frame I. At the same time, the screw VI-15 is used to connect the fixing block VI-13 to the damping block VI-14 below. The centerline of the two screws is at a right angle, and the seat bottom tube is stabilized under the fixing of the damping block VI-14. Wherein, the surface where the damping block VI-14 contacts the seat bottom tube is a high friction performance material, and the structural surface is protruding. By adjusting the two screws, the relaxation degree between the seat bottom tube and the frame I can be regulated, thereby achieving the up and down movement of the seat bottom tube.

### Embodiment 2

In another typical embodiment of the present disclosure, as shown in FIG. 1 to FIG. 18, a manufacturing method for a carbon fiber track bicycle is provided.

A manufacturing method for a carbon fiber track bicycle includes the following steps:
cutting carbon fiber cloth to obtain carbon cloth pieces, and winding the carbon cloth pieces into an inner core mold according to a preset layout method;
painting a mold release agent to an outer mold shell, then placing the inner core mold wrapped with the carbon cloth pieces inside the outer mold shell;
heating and pressurizing to solidify the carbon cloth pieces into shape, removing the inner core mold to obtain a carbon fiber integrated frame I;
installing other assemblies of the track bike onto the carbon fiber integrated frame I.

In this embodiment, the frame I adopts the manufacturing of the inner and outer molds of vacuum airbag integrating molding technology. The inner core mold is made of foaming material, which can not only meet the requirements of supporting and shaping the external carbon fiber layer, but also can be removed after solidification. In this embodiment, the inner core mold can be made of the foaming material polystyrene foam polymer. The surface of the inner core mold is coated with latex to ensure a smooth inner surface of frame I after demolding. Frame I is formed by solidification with carbon fiber cloth, which is a degradable epoxy resin based nano reinforced carbon fiber composite material. The T1100 model of super carbon fibre is selected, carbon nanotube powder is added during the component manufacturing process, and the carbon fiber composite material adopts a monocoque molding process.

In the manufacturing process of frame I, carbon fiber cloth is used as the basic material. According to the pre-designed and optimized carbon fiber cloth, it is cut into carbon cloth pieces. After production, several carbon cloth pieces are placed according to the labels, and the direction of carbon fibers in the same carbon cloth piece is consistent, then the carbon cloth pieces are wound onto the pre-made inner core mold according to the pre-designed carbon cloth laying method and quantity in different positions. The carbon fiber layers are laid and ensure that the carbon fiber connection is spliced along the width direction, and the splicing gap should be less than 1 mm. Then, the wound inner core mold is placed on the outer mold shell. Before entering the mold, the mold release agent is painted on the outer mold shell, the air nozzle is locked, and the frame I is solidified and formed in a certain shape by heating and pressurizing. The inner core mold is decomposed at high temperature to be removed.

As shown in FIG. 7, the carbon fiber cloth laid on the surface of the inner core mold is configured based on the target direction of carbon fibers at each position. The fiber layers inside the carbon fiber cloth laid on the upper tube I-1, the lower tube I-2, and the seat tube I-3 are distributed along the 0 degree direction, which are distributed along the axial direction of the corresponding tube fittings, to resist the tensile force generated by the forward pushing of frame I during cycling, and provide sufficient bending rigidity to maintain cycling posture and efficiency.

The seat branch tube I-4 is distributed with fiber layers in two different directions, and the fiber layers inside the carbon fiber cloth laid on the seat branch tube I-4 is distributed along the ±45° direction, ensuring that it can withstand the tensile and shear stresses applied by the seat tube I-3 and the tire support shaft. After obtaining the number of layers of carbon fiber cloth on the seat branch tube I-4, the distribution directions of the fiber layers in adjacent layers of carbon fiber cloth are perpendicular to each other, as shown in FIG. 7. The fibers in one layer of the fiber layers inside the carbon fiber cloth are arranged along the +45° direction relative to the axis of the seat branch tube I-4, while the fibers in the adjacent layer of the fiber layers inside the carbon fiber cloth are arranged along the −45° direction relative to the axis of the seat branch tube I-4.

The transmission branch tube I-5 is distributed with fiber layers in three different directions. The fiber layers inside the carbon fiber cloth laid on the transmission branch I-5 are distributed along the 90 degree and ±45 degree directions, ensuring that they can withstand the tensile and shear stresses applied by the seat tube I-3, the tire support shaft, and the pedal force. After obtaining the number of layers of carbon fiber cloth on the transmission branch tube I-5, for the three layers of carbon fiber cloth stacked sequentially, as shown in FIG. 7, the fibers in one layer of the fiber layers inside the carbon fiber cloth are arranged in the 90° direction relative to the axis of the transmission branch tube I-5, and the fibers in the other layer of the fiber layers inside the carbon fiber cloth, which are spaced apart from the former layer, are arranged in the +45° direction relative to the axis of the transmission branch tube I-5. The fibers in another layer of the fiber layers inside the carbon fiber cloth located between the two layers of carbon fiber cloth mentioned above are arranged in the −45° direction relative to the axis of the transmission branch tube I-5.

The five-way tube I-7 is distributed with fiber layers in four different directions, and the fiber layers inside the carbon fiber cloth laid on the five-way tube I-7 are distributed along 0 degree, 90 degree, and ±45 degree directions to resist torsion and shear forces, and increase the local rigidity and strength at the high stress five-way tube I-7. After obtaining the number of layers of carbon fiber cloth on the five-way tube I-7, for the four layers of fiber cloth stacked sequentially, as shown in FIG. 7, the fibers in the first fiber layer of carbon fiber cloth are arranged in a 90° direction relative to the axis of the five-way tube I-7, the fibers in the adjacent second fiber layer of carbon fiber cloth are arranged in the +45° direction relative to the axis of the five-way tube I-7, the fibers in the third fiber layer of carbon fiber cloth are arranged in the −45° direction relative to the axis of the five-way tube I-7, the fibers in the fourth fiber layer of carbon fiber cloth are arranged in the 0° direction relative to the axis of the five-way tube I-7, and the fibers in the fifth fiber layer of carbon fiber cloth are arranged in the 0° direction relative to the axis of the five-way tube I-7. The fibers in the fifth fiber layer of carbon fiber cloth are arranged along the −45° direction relative to the axis of the five-way tube I-7, while the fibers in the sixth fiber layer of carbon fiber cloth are arranged along the +45° direction relative to the axis of the five-way tube I-7. The axis direction of the five-way tube I-7 refers to the axis direction at the connection position between the five-way tube I-7 and other tube fittings.

The parameters of each component after molding are shown in Table 1.

TABLE 1

| | | | Rear | | | |
|---|---|---|---|---|---|---|
| | Head tube | five-way tube | triangle | Head tube | Seat tube | Five-way tube |
| | rigidity | rigid | rigidity | horizontal | vertical | treading |
| Items | (N/mm) | (N/mm) | (N/mm) | force fatigue | force fatigue | force fatigue |
| ISO | 100 | 150 | 40 | Applied force | Applied force | Applied force |
| domestic | | | | 1200N | 1200N | 1200N |
| standard | | | | Tested | Tested | Tested |
| | | | | 50,000 times | 50,000 times | 100,000 times |
| International | 112 | 195 | 50 | 50,000 | 50,000 | 100,000 |
| standard | | | | | | |
| Solution of | 155.2 | 232.1 | 61.25 | 55,000 | 55,000 | 150,000 |
| the | | | | | | |
| disclosure | | | | | | |
| Increased | 39% | 19% | 23% | 10% | 10% | 50% |
| proportion | | | | | | |

The number of layers for laying carbon fiber cloth is theoretically guided by equation 1, wherein σₘₐₓ is the designed maximum stress; σᵤₜ it is the ultimate tensile strength of single-layer carbon fiber materials.

$$N = \frac{{σ}_{max}}{{σ}_{ut}} \qquad ( 1 )$$

The epoxy resin based nano reinforced carbon fiber composite material is based on the theoretical guidance principles of equations 2, 3, and 4. The energy transfer losses of stress waves in the resin layer, the fiber layer, and the resin-fiber composite layer are calculated separately, and the vibration energy transfer losses of stress waves at the resin-fiber interface are obtained. Therefore, active design of damping performance and fiber content is conducted to meet the extreme requirements of shock absorption and noise reduction.

Calculation of kinetic energy of particle vibration:

$${E}_{k} = \frac{1}{2} {\int }_{{t}_{0}}^{{t}_{0} + T} {mv}^{2} ( t ) dt \qquad ( 2 )$$

Calculation of energy transfer loss:

$${W}_{l} = {E}_{k 2} - {E}_{k 1} \qquad ( 3 )$$

Exponential transmission attenuation coefficient of planar harmonic wave amplitude:

$${α}_{s} = {[ \frac{{ρ}_{0} {w}^{2} ( 1 + v ) ( 1 - 2 v ) ( \sqrt{{E}^{2} + {η}^{2} {w}^{2}} - E )}{2 ( {E}^{2} + {η}^{2} {w}^{2} ) ( 1 - v )} ]}^{1 / 2} \qquad ( 4 )$$

where ρ₀ is the density of the specimen, E is the elastic modulus, η is the viscosity coefficient, υ Poisson's ratio.

The above is only a preferred embodiment of the present disclosure and is not intended to limit it. For those skilled in the art, the present disclosure may have various modifications and variations. Any modifications, equivalent substitutions, improvements, etc. made within the spirit and principles of the present disclosure shall be included within the scope of the present disclosure.

What is claimed is:

1. A carbon fiber track bicycle, comprising a frame formed by carbon fiber integrated solidification, wherein the frame comprises a front triangular structure composed of an upper tube, a lower tube, and a seat tube, and a rear triangular structure composed of a seat branch tube, a transmission branch tube, and a seat tube; fiber layers corresponding to tube fittings forming the front triangular structure is distributed along an axial direction of the corresponding tube fittings; the seat branch tube is distributed with fiber layers in two different directions, the transmission branch tube is distributed with fiber layers in three different directions, and a five-way tube is distributed with fiber layers in four different directions.

2. The carbon fiber track bicycle according to claim 1, wherein two distribution directions of the fiber layers corresponding to the seat branch tube are perpendicular to each other; two distribution directions of the fiber layers corresponding to the transmission branch tube are perpendicular to each other, and another distribution direction of the fiber layers corresponding to the transmission branch tube is located on an angular bisector of the two distribution directions.

3. The carbon fiber track bicycle according to claim 2, wherein four distribution directions of the fiber layers corresponding to the five-way tube are arranged in an asterisk shape.

4. The carbon fiber track bicycle according to claim 1, wherein a cross-section area of the upper tube perpendicular to its axis gradually decreases along a direction from a front wheel to a rear wheel, and an outer circumference of the upper tube is a conical surface; a cross-section of the lower tube perpendicular to its axis direction is elliptical in shape, and a head tube is provided at the junction of the upper tube and the lower tube using a surface extension; and the seat tube uses a box tube type.

5. The carbon fiber track bicycle according to claim 4, wherein a top surface of the upper tube extends an airfoil protrusion, and an outer surface of the airfoil protrusion is streamlined.

6. The carbon fiber track bicycle according to claim 1, wherein an embedded block is provided at a connection position between the transmission branch tube and the seat branch tube, and a U-shaped groove with an opening facing backwards is provided on the embedded block.

7. The carbon fiber track bicycle according to claim 1, wherein the seat tube is matched with a seat support tube, and a seat system is connected above the seat support tube; the seat system comprises a saddle, a support frame, and an adjustment assembly; the saddle is fixed to the support frame, and the support frame is connected to the seat support tube through the adjustment assembly.

8. The carbon fiber track bicycle according to claim 7, wherein the saddle is a streamlined structure, the seat support tube is in a sliding insertion connection with the seat tube are in a sliding insertion connection, and provided with a locking structure.

9. A manufacturing method for the carbon fiber track bicycle according to claim 1, comprising:
cutting carbon fiber cloth to obtain carbon cloth pieces, and winding the carbon cloth pieces into an inner core mold according to a preset layout method;
painting a mold release agent to an outer mold shell, then placing the inner core mold wrapped with the carbon cloth pieces inside the outer mold shell;
heating and pressurizing to solidify the carbon cloth pieces into shape, removing the inner core mold to obtain a carbon fiber integrated frame;
installing other assemblies of the track bike onto the carbon fiber integrated frame.

10. The manufacturing method according to claim 9, wherein the carbon cloth pieces are wound according to a laying manner and quantity, and adjacent carbon cloth pieces are spliced together along the width direction at the carbon fiber connection.
